(19) United States
(12) Patent Application Publication
(10) Pub. No.: US 2023/0177535 A1
(43) Pub. Date: Jun. 8, 2023

(54) AUTOMATED ESTIMATION OF FACTORS INFLUENCING PRODUCT SALES

(71) Applicant: ACCENTURE GLOBAL SOLUTIONS LIMITED, Dublin 4 (IE)

(72) Inventors: Georgios PASSALIS, Athens (GR); Nikolaos SOUZAS, Athens (GR)

(73) Assignee: ACCENTURE GLOBAL SOLUTIONS LIMITED, Dublin 4 (IE)

(21) Appl. No.: 17/575,372

(22) Filed: Jan. 13, 2022

(30) Foreign Application Priority Data
Dec. 8, 2021 (EP) 21386076.0

(51) Int. Cl. G06Q 30/02

(52) U.S. Cl. CPC G06Q 30/0202

(57) ABSTRACT

Systems and methods for facilitating automated estimation of factors influencing product sales are disclosed. The system may include a data pre-processor and a data analyzer. The data pre-processor may generate an input dataset that may pertain to a captured trend of product sales associated with a product. The data analyzer may analyze the input dataset using a state space model to generate a state space representation indicative of a plurality of observations. The data analyzer may process the state space representation through Kalman filtering algorithm combined with the state space model to facilitate estimation of a state variable. The state variable may be indicative of a factor influencing the captured trend. Based on the factor influencing the captured trend of product sales, the system may generate one or more automated insights.

### BACKGROUND

Industries or organizations rely on historical trends and human expertise to analyze factors impacting demand of a product in sales process. The demand may increase or decrease over a period of time. In a complex market landscape, the change in the demand may be influenced by several known and unknown factors or drivers. As the factors may drastically impact the sales performance of a product, it may be necessary to identify and track these factors to facilitate better reasoning behind an observed sales trend. However, the identification of factors, especially unknown factors, may be challenging especially due to lack of historical information or trend.

Further, organizations may need a platform to assist execution of data driven decisions for improvement in their financial metrics. This may crucial as an effective understanding of the trend/patterns in a sales process may also facilitate to establish price aspects such as, for example, a price elasticity of the product. In another example, evaluation of incremental sales may allow to assess the effect of promotional activities in reference to a baseline or base sale volume, which correspond to non-promoted sales. Therefore, it may be important to develop a better understanding on price responsiveness and promo effectiveness to account for effect of price change and promotional activity, respectively on the product sales. This evaluation may empower the organization to take informed decisions for effective strategic management of revenue. Furthermore, the solution may also need to be scalable, user friendly, and customizable based on various criteria such as, for example, type of industry, geographical location of sales and other such aspects.

### SUMMARY

An embodiment of present disclosure includes a system. The system may include a data pre-processor and a data analyzer. The data pre-processor may generate, an input dataset by utilizing a raw dataset. The input dataset may pertain to a captured trend of product sales associated with a product. The raw dataset may pertain to one or more data elements associated with the product sales. The captured trend may pertain to a pattern depicting at least one of a relative increase in demand of the product and a relative decrease in the demand of the product recorded over a definite period of time. The data analyzer may analyze the input dataset using a state space model. Based on the analysis, the data analyzer may generate a state space representation indicative of a plurality of observations. The plurality of observations may be related to at least one activity causing the captured trend. The data analyzer may process the state space representation through Kalman filtering algorithm combined with the state space model. This may facilitate estimation of a state variable corresponding to an observation of the plurality of observations. The state variable may be indicative of a factor influencing the captured trend. The factor may include at least one of a known factors and unknown factors. The state variable may be estimated by a sequential processing of the plurality of observations based on conditional dependence between a sales variable and an independent variable tested in the system. Based on the factor influencing the captured trend of product sales, the system may generate one or more automated insights.

Another embodiment of the present disclosure may include a method for facilitating automated estimation of factors influencing product sales. The method may include a step of collecting, by a processor, an input dataset that may pertain to a captured trend of product sales associated with a product. The raw dataset may pertain to one or more data elements associated with the product sales. The captured trend may pertain to a pattern depicting at least one of a relative increase in demand of the product and a relative decrease in the demand of the product recorded over a definite period of time. The method may include a step of analyzing, by the processor, the input dataset using a state space model to generate a state space representation indicative of a plurality of observations. The plurality of observations may be related to at least one activity causing the captured trend. The method may include a step of processing, by the processor, the state space representation through Kalman filtering algorithm combined with the state space model. This may facilitate estimation of a state variable pertaining to a state corresponding to an observation of the plurality of observations. The state variable may be indicative of a factor influencing the captured trend. The factor may include at least one of a known factor and an unknown factor. The state variable may be estimated by a sequential processing of the plurality of observations based on conditional dependence between a sales variable and an independent variable tested in the system. The method may include a step of generating, by the processor, one or more automated insights based on the factor influencing the captured trend of product sales.

Yet another embodiment of the present disclosure may include a non-transitory computer readable medium comprising machine executable instructions that may be executable by a processor to generate an input dataset by utilizing a raw dataset. The input dataset may pertain to a captured trend of product sales associated with a product. The raw dataset may pertain to one or more data elements associated with the product sales. The captured trend may pertain to a pattern depicting at least one of a relative increase in demand of the product and a relative decrease in the demand of the product recorded over a definite period of time. The processor may analyze the input dataset using a state space model. Based on the analysis, the data analyzer may generate a state space representation indicative of a plurality of observations. The plurality of observations may be related to at least one activity causing the captured trend. The processor may process the state space representation through Kalman filtering algorithm combined with the state space model. This may facilitate estimation of a state variable. The state variable may pertain to a state corresponding to an observation of the plurality of observations. The state variable may be indicative of a factor influencing the captured trend. The factor may include at least one of a known factor and an unknown factor. The state variable may be estimated by a sequential processing of the plurality of observations based on conditional dependence between a sales variable and an independent variable tested in the system. Based on the factor influencing the captured trend of product sales, the processor may generate one or more automated insights.

### BRIEF DESCRIPTION OF DRAWINGS

FIG. 1A illustrates a system for facilitating automated estimation of factors influencing product sales, according to an example embodiment of the present disclosure.

FIG. 1B illustrates an overall implementation for facilitating automated estimation of factors influencing product sales by utilizing the system of FIG. 1A, according to an example embodiment of the present disclosure.

FIG. 2A illustrates an exemplary representation of data elements for facilitating automated estimation of factors influencing product sales, according to an example embodiment of the present disclosure.

FIG. 2B illustrates an exemplary representation for pre-processing of raw dataset, according to an example embodiment of the present disclosure.

FIG. 3 illustrates an exemplary data vault representation, according to an example embodiment of the present disclosure.

FIG. 4 illustrates an exemplary representation of an equation corresponding to additive model for Kalman filtering algorithm, according to an example embodiment of the present disclosure.

FIG. 5 illustrates an exemplary representation of captured trend of product sales and predicted trend based on the automated insights, according to an example embodiment of the present disclosure.

FIG. 6 illustrates an exemplary representation of a state variable derived by Kalman filtering algorithm, according to an example embodiment of the present disclosure.

FIG. 7 illustrates an exemplary representation of regression model applied in Kalman filtering, according to an example embodiment of the present disclosure.

FIG. 8 illustrates a hardware platform for implementation of the disclosed system, according to an example embodiment of the present disclosure.

FIG. 9 illustrates flow diagram for facilitating automated estimation of factors influencing product sales, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “a” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

### Overview

Various embodiments describe providing a solution in the form of a system and a method for facilitating automated estimation of factors influencing product sales. The system may include a data pre-processor and a data analyzer. The data pre-processor may generate an input dataset by utilizing a raw dataset. The input dataset may pertain to a captured trend of product sales associated with a product. The captured trend may pertain to a pattern depicting at least one of a relative increase in demand of the product and a relative decrease in the demand of the product recorded over a definite period of time. The data analyzer may analyze the input dataset using a state space model. Based on the analysis, the data analyzer may generate a state space representation indicative of a plurality of observations. The plurality of observations may be related to at least one activity causing the captured trend. The data analyzer may process the state space representation through Kalman filtering algorithm combined with the state space model. This may facilitate estimation of a state variable indicative of a factor influencing the captured trend. The factor may include at least one of a known factor and an unknown factor, which may be grouped under baseline sales. The state variable may be estimated by a sequential processing of the plurality of observations based on conditional dependence between a sales variable and an independent variable tested in the system. Based on the factor influencing the captured trend of product sales, the system may generate one or more automated insights. In an example embodiment, the system may also include a data vault generator to generate a data vault representation. The data vault representation may include relevant information pertaining to at least one of product sales, product attributes, promotional activities and financial data over a period of time. In an example embodiment, the data vault representation is generated using at least one of the raw dataset and the input dataset.

Exemplary embodiments of the present disclosure have been described in the framework of for facilitating automated estimation of factors influencing product sales. This is mainly to accurately estimate different drivers impacting product sales for each product. In an example embodiment, the implementation of state space model and Kalman filtering algorithm may accurately quantify the impact of different drivers on sales to account for unknown drivers for each product. The automated estimation may also eliminate need for manual intervention and skill dependencies. In an example embodiment, the data vault representation may facilitate a unified data model based flexible implementation to accommodate multiple data elements or key performance indicators from external and internal sources of raw dataset and to update dynamic changes in the data elements. The automated estimation of factors and/or the generation of the data vault representation facilitate to build a fully automated, scalable and user-friendly system. The overall system may thus assist in answering questions on price responsiveness and the promo effectiveness for improving sales of the product. In an example embodiment, the proposed implementation may utilize a combination of various components such as cloud architecture, data schemas, time series modeling algorithms and occupational expertise to scale thousands to million models using modern architecture on a platform, such as, for example, Azure stack. However, one of ordinary skill in the art will appreciate that the present disclosure may not be limited to such applications/platform. In an example embodiment, based on output of analysis or automated insights, the system can also facilitate automated execution of one or more actions associated with the product sales.

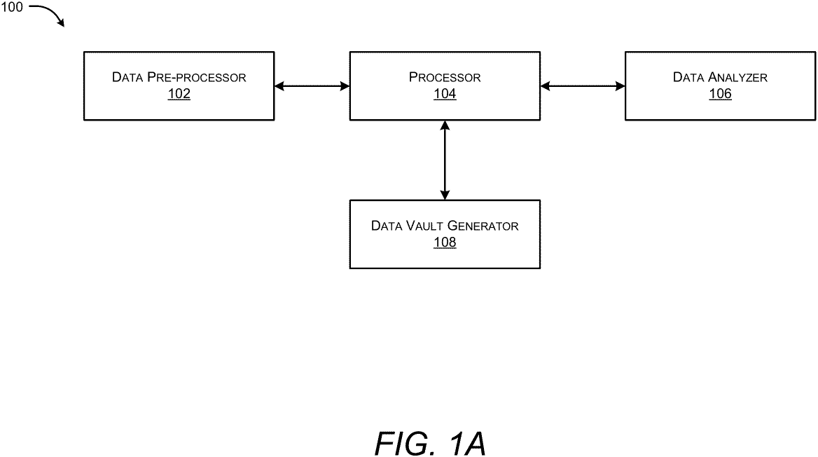

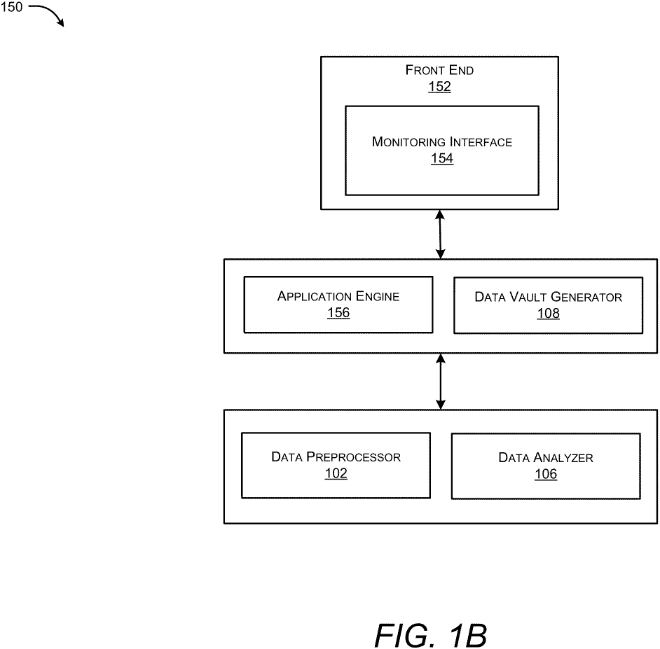

FIG. 1A illustrates a system 100 for facilitating automated estimation of factors influencing product sales, according to an example embodiment of the present disclosure. The system 100 may be implemented by way of a single device or a combination of multiple devices that are operatively connected or networked together. The system 100 may be implemented in hardware or a suitable combination of hardware and software. The components of the system 100 may be implemented in core and/or back end of the overall architecture. The system 100 includes a processor 104 including a data pre-processor 102 and a data analyzer 106. The data pre-processor 102 may generate an input dataset pertaining to a captured trend of product sales associated with a product. In an example embodiment, the captured trend may pertain to a pattern depicting at least one of a relative increase in demand of the product and a relative decrease in the demand of the product recorded over a definite period of time. The data analyzer 106 may analyze the input dataset using a state space model to generate a state space representation indicative of a plurality of observations. The plurality of observations may be related to at least one activity causing the captured trend. In an example embodiment, the data analyzer 106 may process the state space representation through Kalman filtering algorithm combined with the state space model. This may facilitate estimation of a state variable pertaining to a state corresponding to an observation of the plurality of observations. The state variable may be indicative of a factor influencing the captured trend. The state variable may be estimated by a sequential processing of the plurality of observations based on conditional dependence between a sales variable and an independent variable tested in the system. Based on the factor influencing the captured trend of product sales, the system 100 may further generate one or more automated insights. In an example embodiment, the captured trend may pertain to sale of the product. The one or more automated insights may facilitate to measure an impact of the activity pertaining to the captured trend on the sale of the product. In an alternate embodiment, the one or more automated insights may facilitate to perform at least one of a measurement and tracking of the factor influencing the captured trend of the product sales. In an example embodiment, the system 100 may also include a data vault generator 108 to generate a data vault representation. The data vault representation may include relevant information pertaining to at least one of product sales, product attributes, promotional activities and financial data over a period of time. The relevant information may correspond to the one or more data elements associated with the product sales In an example embodiment, the data vault representation may be generated using at least one of the raw dataset and the input dataset.

The system 100 may be a hardware device including the processor 104 for executing machine readable program instructions to facilitate automated estimation of factors influencing product sales. Execution of the machine readable program instructions by the processor 104 may enable the proposed system to facilitate automated estimation of factors influencing product sales. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor 104 may include, for example, microprocessors, microcomputers, microcontrollers, digital signal processors, central processing units, state machines, logic circuits, and/or any devices that manipulate data or signals based on operational instructions. Among other capabilities, processor 104 may fetch and execute computer-readable instructions in a memory operationally coupled with system 100 for performing tasks such as data processing, input/output processing, data extraction, and/or any other functions. Any reference to a task in the present disclosure may refer to an operation being or that may be performed on data.

FIG. 1B illustrates an overall implementation 150for facilitating automated estimation of factors influencing product sales by utilizing the system of FIG. 1A, according to an example embodiment of the present disclosure. As illustrated in FIG. 1B and in accordance with an example embodiment, the data pre-processor 102 may collect raw dataset from one or more sources (a raw data source) to generate the input dataset. In an example embodiment, the raw dataset, collected from the one or more sources, may be pre-processed by extract, transform and load (ETL) mechanism to consolidate various datasets to store as the input dataset. Based on the processing of the input dataset, the data analyzer 106 may facilitate deriving automated insights. In an example embodiment, the automated insights may answer questions related to why a certain pattern is observed in the trend of product sales. For example, the automated insights may provide the answer to a question such as why product sales increased or decreased in a given period of time. As another example, the automated insights may provide an answer to a question such as which factors/drivers played a key role or impacted the sale of the product, either positively or negatively. Several other aspects may be explained based on the automated insights. In an example embodiment, the data analyzer 106 may include time series models to understand promotional activity based performance in reference to baseline (or base sales). The term “base sales” may pertain to an estimated value of product sales in absence of merchandizing/marketing/promotional activity.

In an example embodiment, the data pre-processor 102 and the data analyzer 106 may be back-end components and the data vault generator 108 may be a core component. The architecture may also include application engine 156 that may positioned as a core component. The application engine 156 may pertain to microservices that facilitate interaction between front-end components, the back-end components and the core components. The implementation may also include a monitoring interface 154 at front-end 152. The monitoring interface 154 may monitor performance of an entity or a brand associated with the product. In an example embodiment, the system may quantify impact of different drivers tested in a model through backend component of the data analyzer 106. The backend component of the data analyzer 106 leverages the state space modelling and Kalman Filtering. Based on the quantification of the impact, the system may produce corresponding outputs that may be fed to front end 152 and monitoring interface 154. In an example embodiment, the front end 152 and monitoring interface 154 may be built in Azure PowerBI and Powerapps components. Further, a rich set of PowerBI Dashboards may be available to monitor the sales and the promotional performance. The monitoring interface 154 may also facilitate to perform at least one of a measurement and tracking of the factor influencing the trend of the product sales.

The raw dataset may be collected from one or more raw data sources storing raw data pertaining to the one or more data elements. The raw data sources may include at least one of an internal source and an external source. In an example embodiment, the internal source may include an organization associated with the product. For example, the internal source may include one or more entities that may be associated with at least one of product research, product manufacturing, product assembly, product marketing, entity associated with brand of the product and other entities indirectly or directly associated with the product. The external source may include an organization that collects information associated with at least one of a product survey, market research, and competitor survey and product purchase trend pertaining to the product. In an example embodiment, the external source be a third party entity that may be only concerned with accumulation/recording of a public survey for evaluating increase or decrease in demand/popularity of the product. In an example embodiment, the product may include, for example, consumer goods, services, experiences, convenience, shopping items, specialty goods, industrial goods and any other such product or service that may be purchased or may be available for sales. Several other types of products may also be included.

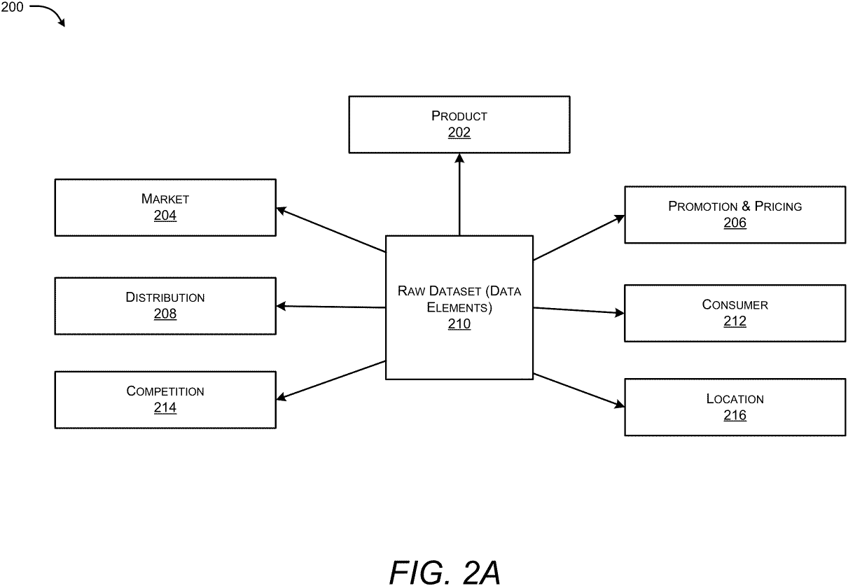

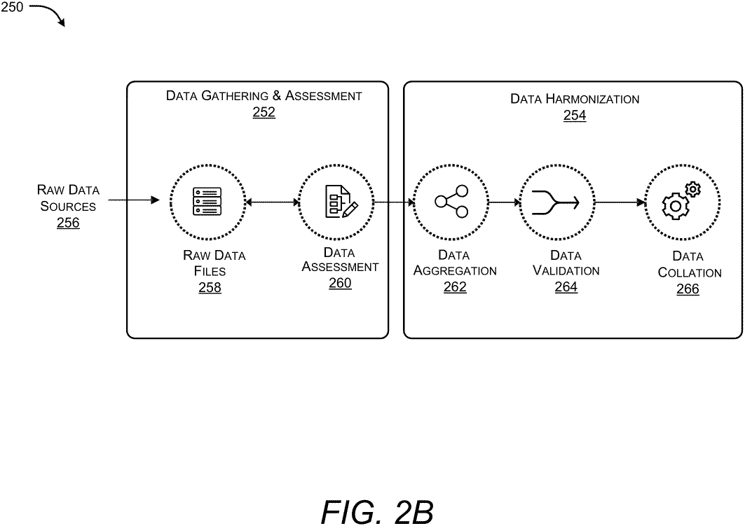

The raw dataset may pertain to one or more data elements associated with the product sales. FIG. 2A illustrates an exemplary representation of data elements for facilitating automated estimation of factors influencing product sales, according to an example embodiment of the present disclosure. As illustrated in FIG. 2A and as per an example embodiment, the one or more data elements may pertain to an attribute associated with at least one of a location attribute 216, a consumer attribute 212, a product attribute 202, a market attribute 204, a competition attribute 214, a distribution attribute 108, a pricing and a promotional attribute (206), and other such attributes. In an example embodiment, the product attribute 202 may be recorded as a master data for each product. As an example, the product attribute 202 may include information pertaining to quantity of product sales in a historical timeline, product hierarchy, product characteristics and other aspects pertaining to the product. The term “product hierarchy” may pertain to a representation of hierarchical relationships between various products and groups/categories of products at various hierarchy levels. For example, a higher hierarchy level offset may include the category “food” such that “frozen food” may be next lower hierarchy level to which a product, such as, for example, “pizza” may belong. The quantity of product sales in a historical timeline may indicate an increase/decrease in the demand for the product over a definite time period. The “product characteristics” may pertain to a property of the product including at least one of physical characteristics, chemical characteristics, product storage costs, product storage requirements, shelf-life of the product, product manufacture costs and other such aspects pertaining to the product.

In an example embodiment, the consumer attribute 212 may pertain to at least one of purchase frequency, Share of Wallet (SOW), socio-demographic data or demographics, lifestyle of consumer, macro-economic factors and other such information associated with a consumer of the product. The SOW may provide information pertaining to an amount that an existing consumer may spend regularly on a product from a particular entity/brand instead of choosing the products from competing brands/entities. The socio-demographic data may indicate characteristics of a consumer with respect to at least one of age, gender, ethnicity, religion, education level, income, type of consumer, nature of profession, location of the consumer, marital status, family attributes, nationality and other information related to the consumer. The lifestyle of the consumer may indicate the purchase routines/preferences of the consumer based on their affordability. The product sales or demand of a product may also be influenced as per the macro-economic factors. For example, aspects such as fiscal parameters, natural parameters, or geopolitical event can largely affect a regional or national economy, which in turn may also affect product demand. The macro-economic factors may include parameters such as, for example, gross domestic product (GDP), employment rate, inflation rate, government debt and other such aspects. The collection of data pertaining to consumer attribute 212 may thus enable to evaluate general/specific affordability of a population and/or demand of the product based on different types of consumers. In an example embodiment, the distribution attribute 208 may pertain to information related to inventory, stock-out, in-store availability, and stock to sales ratio related to the product. The term “stock-out” may pertain to a decrease of the product sales in the post promo period due to consumer pantry loading effect. The stock to sales ratio may also indicate the nature of product sales. In an example embodiment, the location attribute 216 may pertain to storage/sales site of the product such as, for example, location/store at which product may be available for sales, proximity of the store to a manufacturing site, proximity of the store to a location with high consumer demand, proximity of two stores selling the same product and other location based characteristics. In an example embodiment, the market attribute 204 may pertain to increase/decrease in product sales as evaluated based on market survey/research such as, for example, trend, seasonality, special events, public holidays, product preference surveys and other such aspects. The competition attribute 214 may include attributes of a competitor product of similar category/type manufactured by a competitor entity/brand. In an example embodiment, the competition attribute 214 may include aspects related to the competitor product such as, for example, competitor product promotion, competitor product attributes, competitor product market share and other such aspects.

In an example embodiment, the promotional attribute 206 may pertain to details/influencing aspects pertaining to a promotional event such as promotional calendar, promotional mechanics, promotional support and other associated aspects. The term “promotional mechanics” may pertain to a strategy of engaging consumers in product campaign/interactive events by ensuring guaranteed rewards. In an example embodiment, the pricing attribute 206 may pertain to aspects that influence product price such as trade spend, promotion investment, inventory cost, cost of goods sold (COGS) and other aspects. The term “trade spend” may pertain to amount of money that a manufacturer provides to a product sales entity for the purposes of selling the product to consumers. The term COGS may pertain to direct costs of manufacturing the product, which includes the cost of the materials and labor directly used to manufacture the product.

In an example embodiment, the data pre-processor may pre-process the raw dataset collected from a raw data source to generate the input dataset. The raw data source includes at least one of an internal source and an external source storing raw data pertaining to the one or more data elements. FIG. 2B illustrates an exemplary representation 250 for pre-processing of raw dataset, according to an example embodiment of the present disclosure. As illustrated in 250, the raw dataset 258 (or raw data files) from raw data sources 256 may be collected by the data pre-processor 102 (of FIG. 1A). In an example embodiment, the raw dataset may be collected and assessed at 252 followed by data harmonization at 254. For example, the raw dataset 258 may be pre-processed by at least one of a data quality assessment and data structuring 260, data aggregation 262, data validation 264 and data collation 266. The step at 260 may include the data quality assessment and data structuring. The term data structuring may refer to the creation of granularity data tables at a pre-defined time interval, for example weekly. The granularity data tables may be related to aspects such as, for example, sales of the product, promotional execution, prices, and other such aspects. In an example embodiment, the assessment of the raw dataset may be performed to identify presence of missing information such that the assessed dataset may be processed for data structuring for transformation into a structured dataset. Further data quality checks may be applied to review the distribution of the values of each feature as well as outlier detection. In an example embodiment, the raw dataset 258 may be gathered from product related entity such as, for example, product manufacturing entity, product marketing entity and other internal sources. In an alternate embodiment, the raw dataset may also be collected from a third party that may capture consumer behavior/trends such as, for example, Nielsen, Information Resources, Inc (IRI) and other external sources. Based on the collected raw datasets, the missing information/gaps may be identified to ensure that data is ready for processing. In an example embodiment, the missing information may be replaced with a feedback based data to obtain an assessed dataset. The assessed dataset may be transformed to convert an unstructured data into easily ingestible templates for the ease of data processing. In an example embodiment, the structured dataset may be subjected to the data aggregation 262. The data aggregation 262 may combine one or more digital documents in the structured dataset into an aggregated dataset. In an example embodiment, the data aggregation 262 may be performed at planning level for analysis. The data aggregation (or roll up at higher level - for example, from product to product group level) may be performed taking into consideration the nature of each feature. For example, sales can be summed, however, the price may be considered in terms of an average or a weighted average value. The data validation 264 may compare information in the aggregated dataset with pre-defined information to obtain a validated dataset. In an example embodiment, the data validation 264 may include comparison of information pertaining to sales (such as, for example, primary sales from entity/client database) with external sources such as, for example, Nielsen, IRI and other external sources. In an alternate embodiment, the data validation 264 may include comparison of information pertaining to promotional activity/attribute (such as, for example, promotional calendar) with data related to sales such as electronic point of sale (EPOS) or syndicated sales data. The data validation 264 may also include assessment of data quality by performing at least one of treatment of data for missing values, treating for identification/removal of outlier values and correction of occupational inconsistencies. The data collation 266 may be performed to collate individual elements in the validated dataset to generate the input dataset. In an example embodiment, the data collation 266 may be performed by stitching validated datasets and further creating variables and applying transformations for modeling/analytics purpose.

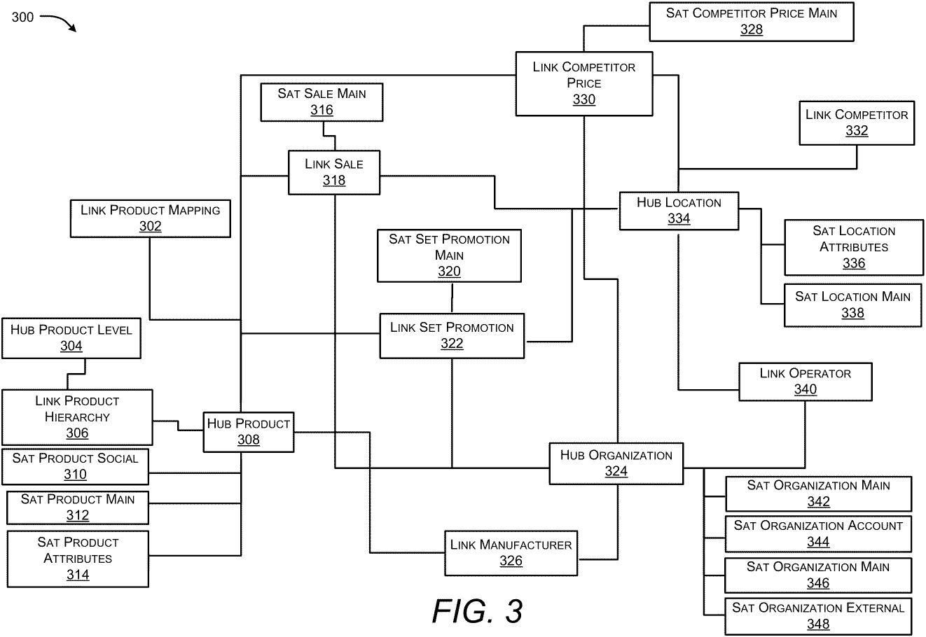

In an example embodiment, the system 100 may also include the data vault generator 108 to generate the data vault representation. The data vault representation may include relevant information pertaining to at least one of product sales, product attributes, promotional activities and financial data over a period of time. The relevant information may correspond to the one or more data elements associated with the product. In an example embodiment, the data vault representation may be generated using at least one of the raw dataset and the input dataset. FIG. 3 illustrates an exemplary data vault representation 300, according to an example embodiment of the present disclosure. As illustrated in FIG. 3, the data vault representation 300 illustrates various data elements that are interlinked to depict an association there between. In an example embodiment, the data vault representation may be in the form of an atomic data model, as illustrated in FIG. 3. The atomic data model in the data vault schema, may facilitate to decouple raw data from a platform. In the instant embodiment, the platform may remain decoupled from data foundation by adopting a layered data modelling approach. In this approach, instead of transforming the raw data directly to an analytical data model, the raw data may be first mapped to the atomic data model. The atomic data model may be then transformed to the analytical data model. The solution/system may be designed for scaling taking into consideration the differences that might occur based on change in location or country. For example, in case of a global roll out, variation in data granularity may be observed. The data vault representation or atomic model may be a simplified form of data model as it allows only specific types of relationships between three basic entities. For example, the three basic entities may be product, organization and location. This approach may prevent ambiguity due to limited features/factors being considered. This may also lead to a consistent outcome even when the approach is implemented by different people and/or different teams involved in data modelling at different points in time. In an example embodiment, the entity details may be attached as separate data tables to a master data entity. This may allow the future customization for different markets by changing the entity details but not changing the master data entities. For example, the entity details related to entity (product) may include, for example, product attributes and/or product hierarchy, which may be attached to a product master data entity. In an alternate example embodiment, data entities may be needed to model relationships between master data entities. For example, a sale transaction may be a relationship between a product, a customer, a sale location and other such factors. Further, the atomic data model may include relationship links that may be unique identifiers within master data entities. However, the relationship links may not be created between entity details or between other relationships. In an example embodiment, the atomic data model may also include reference data entities such as, for example, calendar, currencies and other such entities, which may be captured using Data Vault terminology. Typical atomic data model may include terms/representation in a standard format, such as, for example, master data entities represented as HUBS (_HUB). For example, as illustrated in FIG. 3, the master data entity (HUBS) may pertain to entities as product (HUB product level 304, HUB product 308), organization (HUB organization 324) and location (HUB location 334). The entity details may be represented as SATELLITES (_SAT). For example, as illustrated in FIG. 3, the entity details (SATELLITES) may include details about the master entity such as, for example, SAT product social 310, SAT product main 312 and SAT product attributes 314 may relate to details pertaining to product as the entity (HUB product 308). In another example, the master entity location (HUB location 334) may include entity details such as, for example, SAT location attributes 336, SAT location main 338. In yet another example, the master entity such as organization (HUB organization 324) may include entity details such as, for example, SAT organization main (342 and 346), SAT organization external 348 and SAT organization account 344. Further, the relationship links may be represented as LINKS (_LINK). For example, the HUB product 308 and the HUB product level 304 may be linked by a relationship i.e. LINK product hierarchy 306. In another example, the HUB product 308 and the HUB organization 324 may be linked by a relationship i.e. LINK manufacturer 326. In yet another example, the HUB organization 324 and the HUB location 334 may be linked by a relationship i.e. LINK operator 340 and LINK sale 318. In yet another example, the HUB location 308 and the HUB product 308 may be linked by a relationship i.e. LINK product mapping 302, LINK competitor price 330 and LINK competitor 332. In yet another example, the HUB product 308, the HUB organization 324 and the HUB location 334 may be linked by a relationship i.e. LINK set promotion 332. Further, each link may be associated with link details (SAT). For example, the link details related to LINK sale 318 may be SAT sale main 316. The link details related to LINK competitor price 330 may be SAT competitor price main 328. The link details related to LINK set promotion 322 may be SAT set promotion 320. Furthermore, the reference data may be represented as REFERENCE (_REF). It may be appreciated that the atomic data model provided in FIG. 3 may be exemplary and hence may not be limited by the mentioned entities and/or relationships, which may vary with variation in other factors.

The system 100 utilizes a state space model to analyze the input dataset to generate a state space representation. The state space representation may be indicative of a plurality of observations related to at least one activity causing the captured trend. In an example embodiment, the state space model may provide a unified representation of a wide range of linear Gaussian time series models such as, for example, Autoregressive Moving Average model (ARMA), time-varying regression models, dynamic linear models and unobserved components time series models. Various other models can also be implemented. In an alternate embodiment, dynamic regression can be formulated using the state space representation of the plurality of observations to which Kalman filtering algorithm can be applied. In an alternate embodiment, a dynamic linear model can be utilized to handle non-stationary processes, missing values, non-uniform sampling or observations with varying accuracies. Based on the state space representation, the Kalman filtering algorithm may process to estimate a state variable. The state variable may pertain to a state corresponding to an observation and may be indicative of a factor influencing the captured trend of product sales. For example, state space model, in combination with Kalman filtering algorithm may facilitate to gain insights on latent states for a given observation y. In an example embodiment, smoothing recursive algorithms may also be used in combination with the Kalman filtering algorithm. An exemplary equation for space state model approach is provided as follows:

The linear Gaussian family state space model with continuous states and discrete time intervals t = 1,...,n

$${y}_{t} = {Z}_{t} {α}_{t} + {∈}_{t} , \left(o b s e r v a t i o n e q u a t i o n\right)$$

$${α}_{t + 1} = {T}_{t} {α}_{t} + {R}_{t} {η}_{t} , \left(s t a t e e q u a t i o n\right) ,$$

where ∈ₜ~ N (0, Hₜ) (model error terms)
ηₜ~ N(O, Qₜ); and
α_{1~} N(α₁, P₁).
wherein, Zₜ, Tₜ and Rₜ are system matrices and Hₜ, Qₜ and P₁ are covariance matrices. The system matrix Zₜ links the unobserved factors and regression effects of the state vector with the observation vector. Thus, the state space model based approach may account for unknown factors that have influenced product sales, which otherwise would not have been known or tracked in the past. This allows for correct measurement of the impact each activity had on the product sales.

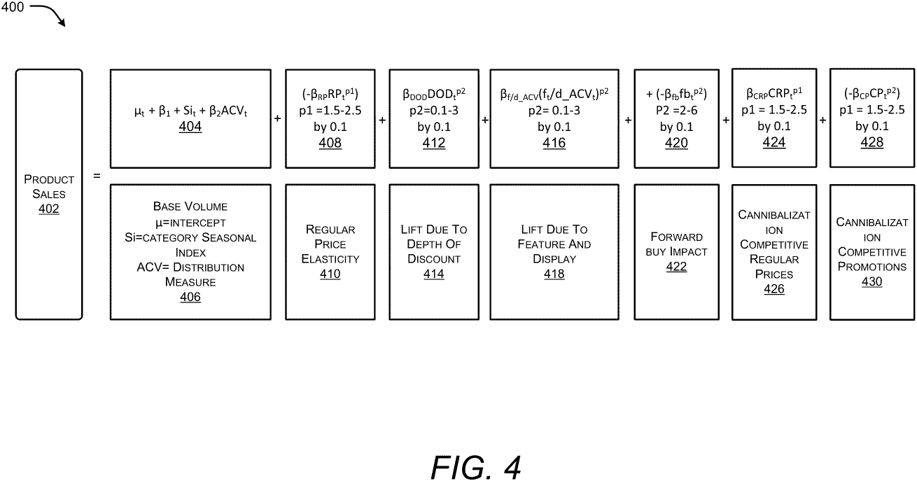

By implementation of the Kalman filtering algorithm combined with the state space model, the state variable may be estimated by a sequential processing of the plurality of observations based on conditional dependence between the sales variable and the independent variables tested in the system. The sales variable may pertain to volume sales of the product, which may represent the total volume of all sales for a pre-defined time duration. For example, assuming the product is a bottle of water with a holding capacity of 500 ml, the sales variable may pertain to total sales volume in liters of the bottles for a time duration, such as, for example, 2 years of weekly sales or 104 weeks. The independent variables (explanatory variables) may represent various features tested in modeling that may enable to explain the sales variation/pattern/trend. For example, the price of the product at weekly level, promotional activity performed, temperature/weather may be examples of independent variables. Further, the state variable may be indicative of the factor influencing the captured trend, wherein the factor may include at least one of a known factor and an unknown factor. In an example embodiment, the Kalman filtering algorithm may evaluate the factor by using an additive function of at least one of a base volume of product, a price elasticity of the product, an increased demand of the product pertaining to discount depth, an increased demand of the product pertaining to feature, increased demand of the product pertaining to display or promotional activity, impact of forward buy, impact of introduction of a cross-product and impact of competition pricing. For example, the Kalman filtering algorithm may be associated with a pre-built additive model that can decompose demand corresponding to product sales into its constituent parameters. FIG. 4 illustrates an exemplary representation 400 of an equation corresponding to additive model for Kalman filtering algorithm, according to an example embodiment of the present disclosure. As illustrated in 400, demand pertaining to the product sales 402 may be a combination of one or more constituent parameters. In an example embodiment, the constituent parameters may pertain to at least one of a base volume 406, regular price elasticity 410, lift due to depth of discount 414, lift due to feature and display 418, forward buy impact 422, cannibalization based on competitive regular prices 426 and cannibalization based on competitive promotions 430. The base volume 406 may correspond to a weighted average of non-promoted product sales in a historical timeline and mainly indicates the demand of the product in absence of merchandizing/promotional activity for the product. In an example embodiment, the constituent parameters may be derived from historical data pertaining to the product sales. The base volume 406 may be represented by additive function 404 as

$${μ}_{\text{t}} + {β}_{1} + {\text{Si}}_{\text{t}} + {β}_{2} {\text{ACV}}_{\text{t}} ,$$

wherein µ represents intercept;
Si represents category seasonal index; and
ACV (All Commodity Volume) represents the weighted distribution measure in a region or group of stores.

The other constituent parameter driving the demand for the product may be regular price elasticity 410. The regular price elasticity 410 may indicate a percentage change in quantity of the product demanded when there is a one percent increase in price considering all other parameters as constant. As per a general theory, for example, the price elasticity being greater than 1 indicates that the product is elastic and that consumers are responsive to price changes. In another example, if the elasticity is -2 may indicate elastic demand as the quantity demanded may fall twice with increase in price - the product is highly elastic and an increase of the price will result to considerable reduction of the sales. In another example, an elasticity of -0.5 may indicate show an inelastic demand wherein the quantity response may be half compared to price increase and hence may be less sensitive to price change. In reference to the equation shown in 400, the regular price elasticity 410 may be represented as (-β_{RP}RPₜ ^{p1}), wherein p1 can be in the range of 1.5 to 2.5 with incremental change of 0.1. β_{RP} is the beta coefficient estimated by the model illustrating the significance of Regular Price to the sales performance and p1 is the power transformation applied to the Regular Price illustrating the non linear relationship between price and sales. The other constituent parameter driving the demand for the product may be lift due to Depth of Discount (DOD) 414, which refers to incremental increase in the product sales based on size of discount in percentage executed as part of a promotional activity. The lift due to depth of discount (DOD) 414 may be represented β_{DOD}DODₜ ^{p2}, wherein p2 can be in the range of 0.1 to 3 with incremental change of 0.1 capturing the non linear relationship between the Depth of Discount and the sales. The other constituent parameter may be lift due to feature and display 418 that refers to incremental increase in the product sales based on endorsement of the product in a product sales location. The lift due to feature and display 418 may be represented β_{f/d-ACV}(ft/d_ACVt)^{p2}, wherein p2 can be in the range of 0.1 to 3 with incremental change of 0.1. The other constituent parameter impacting product demand may be forward buy impact 422 that refers to advance purchase of product by an entity to secure the product at a lower price such that the product sales can occur later at a relatively higher price. The forward buy impact 422 may be represented as (-β_{fb}fbₜ ^{p2}), wherein p2 can be in the range of 2 to 6 with incremental change of 0.1. In an example embodiment, the cannibalization based on competitive regular prices 426 and cannibalization based on competitive promotions 430 may be other constituent parameters impacting the product demand. The term “cannibalization” in product sales refers to decrease in demand of the product due to price changes or promo execution of a similar product by the same manufacturing entity. The cannibalization based on competitive regular prices 426 and cannibalization based on competitive promotions 430 may indicate the change in demand of the product, loss in sales in the case of a competitive promotion and gain in the case of a competitive price increase by a similar product by the same manufacturing entity. The cannibalization based on competitive regular prices 426 may be represented as β_{CRP}CRPₜ ^{p1} wherein p1 can be in the range of 1.5 to 2.5 with incremental change of 0.1. The cannibalization based on competitive promotions 430 may be represented as (-β_{cpc.}Pₜ ^{p2}) wherein p2 can be in the range of 1.5 to 2.5 with incremental change of 0.1. The additive model of the Kalman filtering algorithm considers all the constituent parameters and provides an estimation of the state variable.

The Kalman filtering algorithm may include application of a first Kalman filter pass followed by a second Kalman filter pass to the state space representation to calibrate an effect of the activity pertaining to the captured trend. In an example embodiment, the first Kalman filter pass may facilitate estimation of a baseline and an incremental trend. The baseline may indicate the unknown factor influencing the captured trend, whereas the incremental trend may indicate the known factor influencing the captured trend. For example, in the first pass (or first Kalman filter pass), draft estimates for the baseline may be provided along with incremental rise in product sales. The application of the first Kalman filter pass may facilitate to isolate effects due to known factors and unknown factors. The known factors may be attributed to the incremental rise, wherein the known factors may be the factors that have corresponding historical or pre-existing data. The unknown factors may be attributed to the baseline, wherein the unknown factors may be the factors that do not have corresponding historical or pre-existing data. In an example embodiment, the second pass (or second Kalman filter pass) may facilitate filtering of random noise from the baseline to retain selective information associated with the captured trend that is uninfluenced by a promotional activity. For example, the selective information may be related to the loyal sales that represent product sales in absence of merchandizing/promotional activity for the product. The second Kalman filter pass may thus facilitate to calibrate baseline estimate and isolate loyal sales. In an example embodiment, the second Kalman filter pass may be combined with application of a regression technique to quantify effect of the factor influencing the captured trend. Thus, the first and second Kalman filter pass of baseline, together with the simultaneous estimation of the factor (drivers) contribution to the product sales, may automatically calibrate effect of each activity and therefore will offer a more realistic estimate.

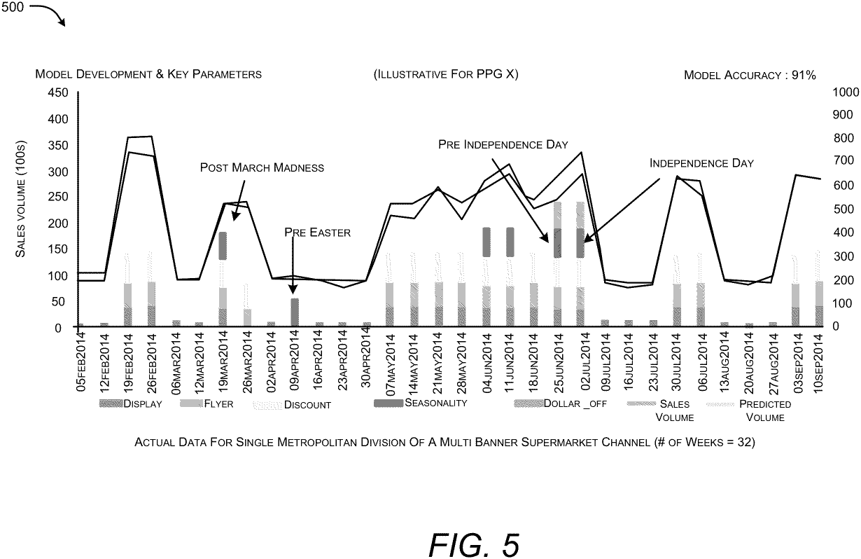

FIG. 5 illustrates an exemplary representation 500 of captured trend of a Promoted Product Group X (Group of products with similar attributes) sales and predicted trend based on the automated insights, according to an example embodiment of the present disclosure. As illustrated in FIG. 5, the graphical representation may indicate predicted volume pertaining to product sales (predicted sales volume) as well as the actual volume pertaining to product sales (actual sales volume), achieving a model accuracy at 91% illustrating the robustness of the model (how much close the predicted sales are close to the actual sales). Based on constituent parameters such as, for example, discount, display, seasonality, and other such parameters, the system 100 may facilitate automated insights based on the analysis performed by Kalman filtering in combination with the state space model. For example, the automated insights may be able to identify unknown factors such as a sudden rise in demand for product (as observed on date 19^{th} March 2014) may be due to post-March madness, which mainly attribute to factor such as seasonality. Similarly the demand for product (as observed on date 2^{nd} July 1014) is only accounted by seasonality factor around pre-independence day and Independence Day. Thus, the system of the present disclosure may enable to account for known and unknown factors that may have caused an increase/decrease in demand of the product with regards to product sales.

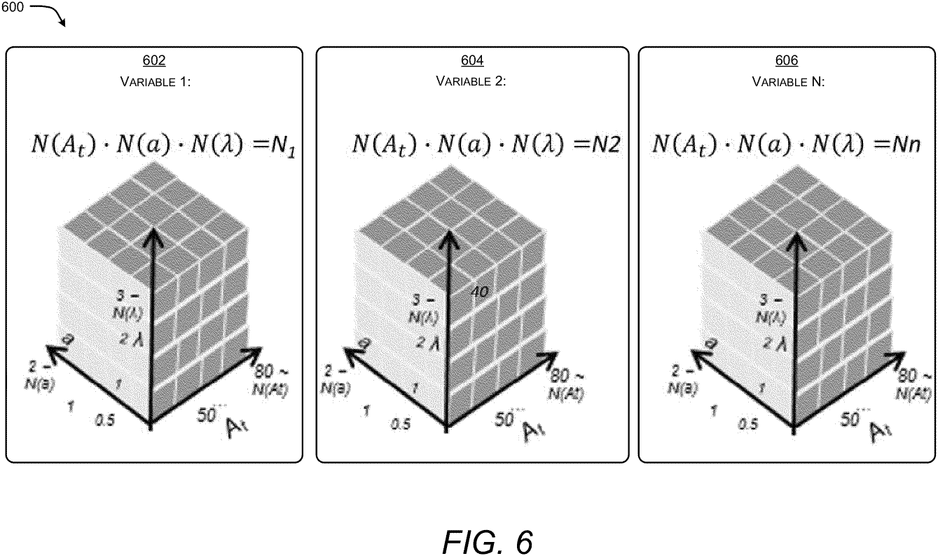

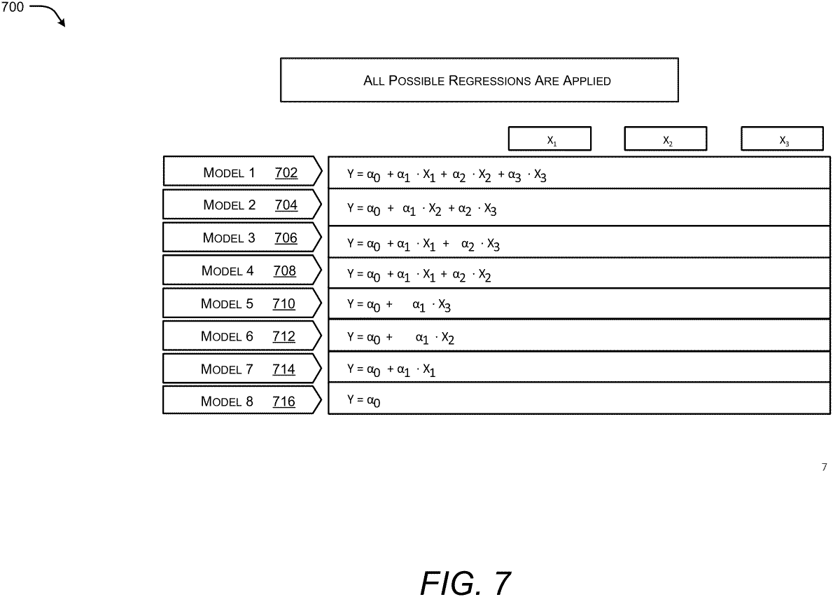

In an example embodiment, the state variable (indicative of the factor) is estimated by Kalman filtering algorithm by a sequential processing of the plurality of observations based on conditional dependence between the sales variable and the independent variables tested in the system. FIG. 6 illustrates an exemplary representation 600 of a state variable used as input by Kalman filtering algorithm, according to an example embodiment of the present disclosure. The exemplary representation 600 refers to a transformation applied in feature prior to modeling such that in each model iteration, a different variant of this feature may be tested. The representation 600 illustrates state variable 1 (602), state variable 2 (604) and state variable n (606). In reference to any of the state variables 1, 2 and N, it may be assumed that any point in the cube (in 602, 604, 606) represents a transformation that is applicable to variable, for example, “n”. This means that each variable may be associated with N(n) variants. In an example embodiment, a complete model may be specified by a unique combination of each of the variants of the variables in the dataset that may result in (N_1. N_2.[... •N](n )) different candidate models. Referring back to FIG. 4, and in accordance with an example embodiment, the first Kalman filter pass may be combined with application of a regression technique to quantify effect of the factor influencing the captured trend. The regression technique may utilize remaining space (that is not analyzed in the first step of filtering noise in the second Kalman filter pass. FIG. 7 illustrates an exemplary representation 600 of regression model applied in Kalman filtering, according to an example embodiment of the present disclosure. As illustrated in FIG. 7, the regression models is a combination of various models i.e. model 1 (702), model 2 (704), model 3 (706), model 4 (708), model 5 (710), model 6 (712), model 7 (714) and model 8 (716). As shown in FIG. 7, Y represents sales variable (pertaining to product sales). In an exemplary embodiment, the sales variable (Y) may represent the volume sales of the product. The independent/explanatory variables are represented as X1, X2 and X3. In an exemplary embodiment, the independent variables may pertain to various features tested in modeling that may explain the sales variation/pattern/trend. For example, the independent variables may include factors such as, for example, price of product at weekly level, promotional activity, temperature/weather and other such reasons. As shown in FIG. 7, different regression models are applied sequentially to quantify the effect of the factors X1, X2 and X3 (referring to the explanatory features such as, for example, regular price, Depth of Discount, and other features.) that affects the product sales. This may be continued until a ‘winning’ or ‘champion’ model may be found, wherein the model explains a reasoning for the actual sales (predicted sales are close to the actual sales) in a best possible manner. In an example embodiment, the quantification may include a sign direction indicating a positive effect or a negative effect. Based on the factors influencing the captured trend of product sales as determined by the Kalman filtering, the system can generate one or more automated insights. The state space algorithrn along with the Kalman Filtering may thus accurately quantify the impact of the independent features (influencing factors) tested in modeling and provide actionable insights to business to define their price-promo strategy. In an example embodiment, the one or more automated insights facilitate to perform at least one of a measurement and tracking of the factor influencing the trend of the product sales. In an example embodiment, the trend may pertain to sale of the product such that the one or more automated insights facilitate to measure an impact of the activity pertaining to the captured trend on the sale of the product. The system of the present disclosure may include improved prediction accuracy with the combination of state space and Kalman Filtering algorithm to generate insights for enhancing revenue growth in terms of increased demand and product sales. The system of the present disclosure may also facilitate improved organizational control by providing analysis based on moving baseline for better interpretation of the pattern. In an example embodiment, the automated solution may be scalable and may be useful for various entities in the field of consumer packaged food (CPG), retail and other similar type of organizations.

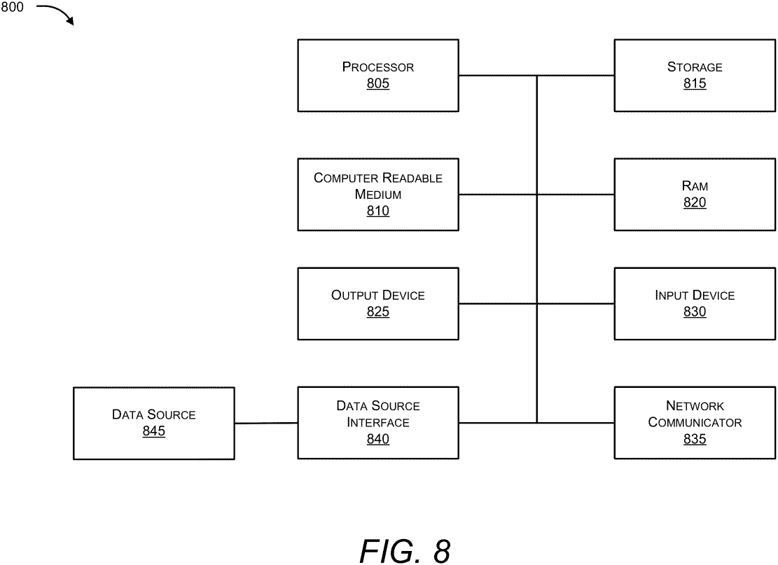

FIG. 8 illustrates a hardware platform (800) for implementation of the disclosed system, according to an example embodiment of the present disclosure. For the sake of brevity, construction and operational features of the system 100 which are explained in detail above are not explained in detail herein. Particularly, computing machines such as but not limited to internal/external server clusters, quantum computers, desktops, laptops, which may be used to execute the system 100 or may include the structure of the hardware platform 800. As illustrated, the hardware platform 800 may include additional components not shown, and that some of the components described may be removed and/or modified. For example, a computer system with multiple GPUs may be located on external-cloud platforms including Microsoft Azure Services, or internal corporate cloud computing clusters, or organizational computing resources, etc.

The hardware platform 800 may be a computer system such as the system 100 that may be used with the embodiments described herein. The computer system may represent a computational platform that includes components that may be in a server or another computer system. The computer system may execute, by the processor 805 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 805 that executes software instructions or code stored on a non-transitory computer-readable storage medium 810 to perform methods of the present disclosure. The software code includes, for example, instructions for automated estimation of factors influencing product sales.

The instructions on the computer-readable storage medium 810 are read and stored the instructions in storage 815 or in random access memory (RAM). The storage 815 may provide a space for keeping static data where at least some instructions could be stored for later execution. The stored instructions may be further compiled to generate other representations of the instructions and dynamically stored in the RAM such as RAM 820. The processor 805 may read instructions from the RAM 820 and perform actions as instructed.

The computer system may further include the output device 825 to provide at least some of the results of the execution as output including, for example, display of one or more results. The output device 825 may include a display on computing devices and virtual reality glasses. For example, the display may be a laptop screen. GUIs and/or text may be presented as an output on the display screen. The computer system may further include an input device 830 to provide a user or another device with mechanisms for entering data and/or otherwise interact with the computer system. The input device 830 may include, for example, a keyboard, a keypad, a mouse, or a touchscreen. Each of these output device 825 and input device 830 may be joined by one or more additional peripherals. For example, the output device 825 may be used to display the results such as automated insights or output from automated estimation of factors influencing product sales.

A network communicator 835 may be provided to connect the computer system to a network and in turn to other devices connected to the network including other clients, servers, data stores, and interfaces, for instance. A network communicator 835 may include, for example, a network adapter such as a LAN adapter or a wireless adapter. The computer system may include a data sources interface 840 to access the data source 845. The data source 845 may be an information resource. As an example, a database of exceptions and rules may be provided as the data source 845. Moreover, knowledge repositories and curated data may be other examples of the data source 845.

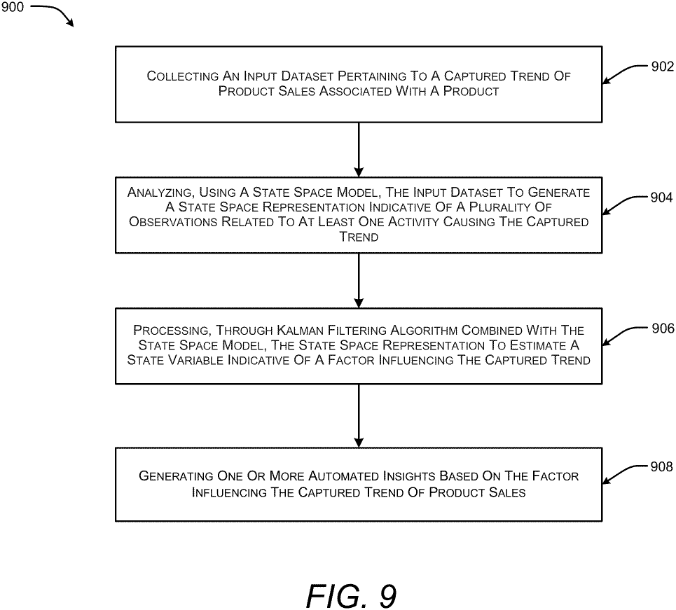

FIG. 9 illustrates flow diagram 900 for facilitating automated estimation of factors influencing product sales, according to an example embodiment of the present disclosure. Referring to FIG. 9, at 902, the method includes a step of collecting, by a processor, an input dataset pertaining to a captured trend of product sales associated with a product. The captured trend may pertain to a pattern depicting at least one of a relative increase in demand of the product and a relative decrease in the demand of the product recorded over a definite period of time. At 904, the method includes analyzing, by the processor, using a state space model, the input dataset to generate a state space representation. The state space representation may be indicative of a plurality of observations related to at least one activity causing the captured trend. At 906, the method includes processing, by the processor, through Kalman filtering algorithm combined with the state space model, the state space representation to estimate a state variable. The state variable may be indicative of a factor influencing the captured trend. The factor may include at least one of a known factor and an unknown factor. In an example embodiment, the state variable may be estimated by a sequential processing of the plurality of observations based on conditional dependence between a sales variable and an independent variable tested in the system. At 908, the method may include generating, by the processor, one or more automated insights based on the factor influencing the captured trend of product sales.

In an example embodiment, the method may include pre-processing, by the processor, a raw dataset collected from a raw data source to generate the input dataset. The raw dataset may be collected from the raw data source that includes at least one of an internal source and an external source. The internal source may include an organization associated with the product and the external source includes an organization that collects information associated with product survey, market research, competitor survey and product purchase trend pertaining to the product. In an example embodiment, processing the state space representation by Kalman filtering algorithm may include applying a first Kalman filter pass followed by a second Kalman filter pass to the state space representation to calibrate an effect of the activity pertaining to the captured trend. The first Kalman filter pass may facilitate an estimation of a baseline and an incremental trend. The baseline may indicate the unknown factor influencing the captured trend, and the incremental trend indicates the known factor influencing the captured trend.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

We claim:

1. A system comprising:
a processor comprising:
a data pre-processor to:
generate, using a raw dataset, an input dataset pertaining to a captured trend of product sales associated with a product, wherein the raw dataset pertains to one or more data elements associated with the product sales, the captured trend pertaining to a pattern depicting at least one of a relative increase in demand of the product and a relative decrease in the demand of the product recorded over a definite period of time;
a data analyzer to:
analyze, using a state space model, the input dataset to generate a state space representation indicative of a plurality of observations related to at least one activity causing the captured trend;
process, through Kalman filtering algorithm combined with the state space model, the state space representation to estimate a state variable pertaining to a state corresponding to an observation of the plurality of observations, the state variable indicative of a factor influencing the captured trend, the factor comprising at least one of a known factor and an unknown factor, wherein the state variable is estimated by a sequential processing of the plurality of observations based on conditional dependence between a sales variable and an independent variable tested in the system;
wherein the system generates one or more automated insights based on the factor influencing the captured trend of product sales.

2. The system as claimed in claim 1, wherein the processor comprises:
a data vault generator to:
generate a data vault representation including relevant information pertaining to at least one of product sales, product attributes, promotional activities and financial data over a period of time, the relevant information corresponding to the one or more data elements associated with the product sales and wherein the data vault representation is generated using at least one of the raw dataset and the input dataset.

3. The system as claimed in claim 2, the data vault generator dynamically updates the relevant information pertaining to the product sales based on inputs received from one or more repositories corresponding to the data elements.

4. The system as claimed in claim 2, wherein the one or more data elements pertain to an attribute associated with at least one of a location attribute, a consumer attribute, a product attribute, a market attribute, a competition attribute, a distribution attribute, a promotional attribute and a pricing attribute.

5. The system as claimed in claim 2, wherein the data pre-processor pre-processes the raw dataset collected from a raw data source to generate the input dataset, wherein the raw data source includes at least one of an internal source and an external source storing raw data pertaining to the one or more data elements.

6. The system as claimed in claim 2, wherein the internal source includes an organization associated with the product, and the external source includes an organization that collects information associated with at least one of a product survey, market research, competitor survey and product purchase trend pertaining to the product.

7. The system as claimed in claim 2, wherein the raw dataset is pre-processed by at least one of a data quality assessment, data structuring, data aggregation, data validation and data collation.

8. The system as claimed in claim 7, wherein the data quality assessment pertains to assessment of the raw dataset to identify presence of missing information, wherein the missing information is replaced with a feedback based data to obtain the assessed dataset, and wherein the assessed dataset is processed for data structuring for transformation into a structured dataset.

9. The system as claimed in claim 7, wherein the data aggregation combines one or more digital documents in the structured dataset into an aggregated dataset, wherein the data validation compares an information in the aggregated dataset with pre-defined information to obtain a validated dataset and wherein the data collation is performed to collate individual elements in the validated dataset to generate the input dataset.

10. The system as claimed in claim 1, wherein the captured trend is based on the demand of the product with respect to at least one of a product pricing and a promotional activity pertaining to the product.

11. The system as claimed in claim 1, wherein the Kalman filtering algorithm comprises application of a first Kalman filter pass followed by a second Kalman filter pass to the state space representation to calibrate an effect of the activity pertaining to the captured trend.

12. The system as claimed in claim 11, wherein the first Kalman filter pass facilitates estimation of a baseline and an incremental trend, wherein the baseline indicates the unknown factor influencing the captured trend, and the incremental trend indicates the known factor influencing the captured trend.

13. The system as claimed in claim 12, wherein the second Kalman filter pass facilitates filtering of random noise from the baseline to retain selective information associated with the captured trend that is uninfluenced by a promotional activity, and wherein the first Kalman filter pass is combined with application of a regression technique to quantify effect of the factor influencing the captured trend.

14. The system as claimed in claim 1, wherein the Kalman filtering algorithm evaluates the factor by using an additive function of at least one of a base volume of product, a price elasticity of the product, an increased demand of the product pertaining to discount depth, an increased demand of the product pertaining to feature, increased demand of the product pertaining to display or promotional activity, impact of forward buy, impact of introduction of a cross-product and impact of competition pricing.

15. The system as claimed in claim 1, wherein the one or more automated insights facilitate to perform at least one of a measurement and tracking of the factor influencing the trend of the product sales, and wherein the trend pertains to sale of the product such that the one or more automated insights facilitate to measure an impact of the activity pertaining to the captured trend on the sale of the product.

16. A method for facilitating automated estimation of factors influencing product sales, the method comprising:
collecting, by a processor, an input dataset pertaining to a captured trend of product sales associated with a product, wherein the captured trend pertains to a pattern depicting at least one of a relative increase in demand of the product and a relative decrease in the demand of the product recorded over a definite period of time;
analyzing, by the processor, using a state space model, the input dataset to generate a state space representation indicative of a plurality of observations related to at least one activity causing the captured trend;
processing, by the processor, through Kalman filtering algorithm combined with the state space model, the state space representation to estimate a state variable indicative of a factor influencing the captured trend, the factor comprising at least one of a known factor and an unknown factor, wherein the state variable is estimated by a sequential processing of the plurality of observations based on conditional dependence between a sales variable and an independent variable tested in the system; and
generating, by the processor, one or more automated insights based on the factor influencing the captured trend of product sales.

17. The method as claimed in claim 16, the method comprising:
evaluating, by the processor, the input dataset to generate a data vault representation including relevant information pertaining to at least one of product sales, product attributes, promotional activities and financial data over
a period of time.

18. The method as claimed in claim 16, the method comprising:
pre-processing, by the processor, a raw dataset collected from a raw data source to generate the input dataset,
wherein the raw dataset is collected from the raw data source that includes at least one of an internal source and an external source, wherein the internal source includes an organization associated with the product and the external source includes an organization that collects information associated with product survey, market research, competitor survey and product purchase trend pertaining to the product.

19. The method as claimed in claim 16, the method comprising:
processing the state space representation by Kalman filtering algorithm comprises:
applying a first Kalman filter pass followed by a second Kalman filter pass to the state space representation to calibrate an effect of the activity pertaining to the captured trend,
wherein the first Kalman filter pass facilitates estimation of a baseline and an incremental trend, wherein the baseline indicates the unknown factor influencing the captured trend, and the incremental trend indicates the known factor influencing the captured trend.

20. The non-transitory computer readable medium, wherein the readable medium comprises machine executable instructions that are executable by a processor to:
collect an input dataset pertaining to a captured trend of product sales associated with a product, wherein the captured trend pertains to a pattern depicting at least one of a relative increase in demand of the product and a relative decrease in the demand of the product recorded over a definite period of time;
analyze, using a state space model, the input dataset to generate a state space representation indicative of a plurality of observations related to at least one activity causing the captured trend;
process, through Kalman filtering algorithm combined with the state space model, the state space representation to estimate a state variable indicative of a factor influencing the captured trend, the factor comprising at least one of a known factor and an unknown factor, wherein the state variable is estimated by a sequential processing of the plurality of observations based on conditional dependence between a sales variable and an independent variable tested in the system; and
generate one or more automated insights based on the factor influencing the captured trend of product sales.
